(19) United States
(12) Patent Application Publication
(10) Pub. No.: US 2018/0234199 A1
(43) Pub. Date: Aug. 16, 2018

(54) OPTICAL TRANSPORT NETWORK WITH IMPROVED SIGNAL LOADING

(71) Applicant: Fujitsu Limited, Kawasaki-shi (JP)

(72) Inventor: Martin Bouda, Plano, TX (US)

(21) Appl. No.: 15/429,999

(22) Filed: Feb. 10, 2017

(51) Int. Cl. H04J 14/02; H04B 10/27; H04B 10/548; H04B 10/572

(52) U.S. Cl. CPC H04J 14/0202; H04J 14/0215; H04B 10/572; H04B 10/27; H04B 10/548; H04J 14/0227

(57) ABSTRACT

Methods and systems for adding optical signals, such as superchannels, to an optical transport network include using a spread tree wavelength allocation in order to reduce cross-phase modulation (XPM). The spread tree wavelength allocation may result in an overall reduction in operating costs for the optical transport network as compared to a first fit wavelength allocation, for example due to reduced equipment costs for a given level of network loading.

### BACKGROUND

### Field of the Disclosure

The present disclosure relates generally to optical communication networks and, more particularly, to optical transport networks with improved signal loading.

### Description of the Related Art

Telecommunication, cable television and data communication systems use optical networks to rapidly convey large amounts of information between remote points. In an optical network, information is conveyed in the form of optical signals through optical fibers. Optical fibers may comprise thin strands of glass capable of communicating the signals over long distances. Optical networks often employ modulation schemes to convey information in the optical signals over the optical fibers. Such modulation schemes may include phase-shift keying (PSK), frequency-shift keying (FSK), amplitude-shift keying (ASK), and quadrature amplitude modulation (QAM).

As data rates for optical networks continue to increase, reaching up to 1 terabit/s (1 T) and beyond, the demands on optical signal-to-noise ratios (OSNR) also increase, for example, due to the use of advanced modulation formats such as QAM and PSK with dual polarization. In addition, phase shifts of optical signals transmitted over optical networks may be observed. The phase shift may be self-phase modulation (SPM) in which light interacts with an optical fiber during transmission. Additionally, cross-phase modulation (XPM) may occur in which one wavelength of light can alter the phase of another wavelength of light. As an optical network becomes increasingly loaded with optical signals, XPM may represent a significant cause of limited reach of the optical signals.

### SUMMARY

In one aspect, a disclosed method is for loading optical transport networks. The method may be performed in an optical transport network having a number of wavelength slots corresponding to a transmission band of the optical transport network. In the method, the transmission band may be used to transmit optical signals carrying at least one channel. The method may include, adding a first optical signal at a first wavelength slot corresponding to a first edge of the transmission band, and adding a second optical signal at a second wavelength slot corresponding to a second edge of the transmission band, the second edge opposite to the first edge with respect to the transmission band. The method may further include adding subsequent optical signals, respectively, to subsequent wavelength slots of the transmission band. In the method, each subsequent optical signal may be added to a subsequent wavelength slot maximally spaced away from wavelength slots previously populated with optical signals.

In any of the disclosed embodiments of the method, adding the subsequent optical signals may further include adding the subsequent optical signals to maintain a symmetric population of the transmission band by the optical signals.

In any of the disclosed embodiments of the method, each of the wavelength slots may represent at least one physical wavelength slice of the transmission band.

In any of the disclosed embodiments of the method, each of the wavelength slots may represent at least a number of physical wavelength slices corresponding to a channel in the optical transport network.

In any of the disclosed embodiments of the method, each of the wavelength slots may represent at least a number of physical wavelength slices corresponding to a superchannel in the optical transport network.

In any of the disclosed embodiments of the method, adding an optical signal to the optical transport network may further include provisioning an optical path for the optical signal in the optical transport network.

In any of the disclosed embodiments of the method, provisioning the optical path may further include provisioning the optical path using a software-defined networking controller.

In any of the disclosed embodiments of the method, the transmission band may be used by a plurality of optical paths transmitting the optical signals, while a center wavelength and a spectral width of each of the wavelength slots, respectively, may be constant among the optical paths.

In any of the disclosed embodiments of the method, the transmission band may be used by a plurality of optical paths transmitting the optical signals, while a center wavelength and a spectral width of each of the wavelength slots, respectively, are varied among at least some of the optical paths.

In another aspect, an optical transport network disclosed. The optical transport network may include a number of wavelength slots corresponding to a transmission band of the optical transport network. In the optical transport network, the transmission band is used to transmit optical signals carrying at least one channel. The optical transport network may further include a network management controller further including a processor and memory media accessible to the processor. In the optical transport network, the memory media may store instructions executable by the processor for adding a first optical signal at a first wavelength slot corresponding to a first edge of the transmission band, and adding a second optical signal at a second wavelength slot corresponding to a second edge of the transmission band, the second edge opposite to the first edge with respect to the transmission band. In the optical transport network, the memory media may further store instructions for adding subsequent optical signals, respectively, to subsequent wavelength slots of the transmission band. In the optical transport network, each subsequent optical signal may be added to a subsequent wavelength slot maximally spaced away from wavelength slots previously populated with optical signals.

In any of the disclosed embodiments of the optical transport network, the instructions for adding the subsequent optical signals may further include instructions for adding the subsequent optical signals to maintain a symmetric population of the transmission band by the optical signals.

In any of the disclosed embodiments of the optical transport network, each of the wavelength slots may represent at least one physical wavelength slice of the transmission band.

In any of the disclosed embodiments of the optical transport network, each of the wavelength slots may represent at least a number of physical wavelength slices corresponding to a channel in the optical transport network.

In any of the disclosed embodiments of the optical transport network, each of the wavelength slots may represent at least a number of physical wavelength slices corresponding to a superchannel in the optical transport network.

In any of the disclosed embodiments of the optical transport network, the instructions for adding an optical signal to the optical transport network may further include instructions for provisioning an optical path for the optical signal in the optical transport network.

In any of the disclosed embodiments of the optical transport network, the network management controller may include a software-defined networking controller.

In yet another aspect, a software-defined networking (SDN) controller is disclosed. The SDN controller may control an optical transport network having a number of wavelength slots corresponding to a transmission band of the optical transport network. In the optical transport network, the transmission band may be used to transmit optical signals carrying at least one channel. The SDN controller may further include a processor and memory media accessible to the processor. In the SDN controller, the memory media may store instructions executable by the processor for adding a first optical signal at a first wavelength slot corresponding to a first edge of the transmission band, and adding a second optical signal at a second wavelength slot corresponding to a second edge of the transmission band, the second edge opposite to the first edge with respect to the transmission band. In the SDN controller, the memory media may further store instructions for adding subsequent optical signals, respectively, to subsequent wavelength slots of the transmission band. In the SDN controller, each subsequent optical signal may be added to a subsequent wavelength slot maximally spaced away from wavelength slots previously populated with optical signals.

In any of the disclosed embodiments of the SDN controller, the instructions for adding the subsequent optical signals may further include instructions for adding the subsequent optical signals to maintain a symmetric population of the transmission band by the optical signals.

In any of the disclosed embodiments of the SDN controller, each of the wavelength slots may represent at least one physical wavelength slice of the transmission band.

In any of the disclosed embodiments of the SDN controller, each of the wavelength slots may represent at least a number of physical wavelength slices corresponding to a channel in the optical transport network.

In any of the disclosed embodiments of the SDN controller, each of the wavelength slots may represent at least a number of physical wavelength slices corresponding to a superchannel in the optical transport network.

In any of the disclosed embodiments of the SDN controller, the instructions for adding an optical signal to the optical transport network may further include instructions for provisioning an optical path for the optical signal in the optical transport network.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of selected elements of an embodiment of an optical transport network;

FIG. 2 shows selected elements of an embodiment of a superchannel power spectrum;

FIG. 3 is a block diagram of selected elements of an embodiment of an optical control plane system for superchannel subcarrier monitoring;

FIG. 4 is a block diagram of selected elements of an embodiment of a software-defined networking (SDN) controller;

FIG. 5A shows selected elements of an embodiment of a first fit wavelength allocation;

FIG. 5B shows selected elements of an embodiment of a spread tree wavelength allocation;

FIG. 6 is a plot of system margin in an optical network as optical signals are added; and

FIG. 7 is a flow chart of selected elements of a method for signal loading in an optical transport network.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

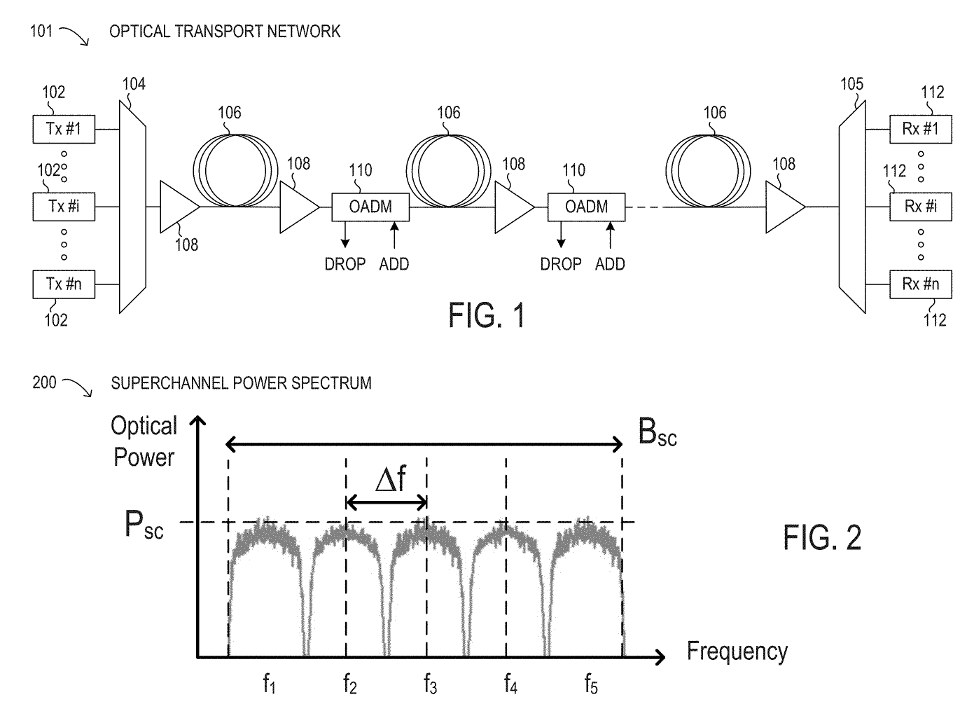

Referring now to the drawings, FIG. 1 illustrates an example embodiment of optical transport network (OTN) 101, which may represent an optical communication system. Optical transport network 101 includes one or more optical fibers 106 to transport one or more optical signals communicated by components of optical transport network 101. The network elements of optical transport network 101, coupled together by fibers 106, may comprise one or more transmitters (Tx) 102, one or more multiplexers (MUX) 104, one or more optical amplifiers 108, one or more optical add/drop multiplexers (OADM) 110, one or more demultiplexers (DEMUX) 105, and one or more receivers (Rx) 112.

Optical transport network 101 may comprise a point-to-point optical network with terminal nodes, a ring optical network, a mesh optical network, or any other suitable optical network or combination of optical networks. Optical transport network 101 may be used in a short-haul metropolitan network, a long-haul inter-city network, or any other suitable network or combination of networks. The capacity of optical transport network 101 may include, for example, 100 Gbit/s, 400 Gbit/s, or 1 Tbit/s. Optical fibers 106 comprise thin strands of glass capable of communicating the signals over long distances with very low loss. Optical fibers 106 may comprise a suitable type of fiber selected from a variety of different fibers for optical transmission. Optical fibers 106 may include any suitable type of fiber, such as a standard Single-Mode Fiber (SMF), Enhanced Large Effective Area Fiber (E-LEAF), or TrueWave® Reduced Slope (TW-RS) fiber.

Optical transport network 101 may include devices to transmit optical signals over optical fibers 106. Information may be transmitted and received through optical transport network 101 by modulation of one or more wavelengths of light to encode the information on the wavelength. In optical networking, a wavelength of light may also be referred to as a “channel” that is included in an optical signal. Each channel may carry a certain amount of information through optical transport network 101.

To increase the information capacity and transport capabilities of optical transport network 101, multiple signals transmitted at multiple channels may be combined into a single wide bandwidth optical signal. The process of communicating information at multiple channels is referred to in optics as wavelength division multiplexing (WDM). Coarse wavelength division multiplexing (CWDM) refers to the multiplexing of wavelengths that are widely spaced having low number of channels, usually greater than 20 nm and less than sixteen wavelengths, and dense wavelength division multiplexing (DWDM) refers to the multiplexing of wavelengths that are closely spaced having large number of channels, usually less than 0.8 nm spacing and greater than forty wavelengths, into a fiber. WDM or other multi-wavelength multiplexing transmission techniques are employed in optical networks to increase the aggregate bandwidth per optical fiber. Without WDM, the bandwidth in optical networks may be limited to the bit-rate of solely one wavelength. With more bandwidth, optical networks are capable of transmitting greater amounts of information. Optical transport network 101 may transmit disparate channels using WDM or some other suitable multi-channel multiplexing technique, and to amplify the multi-channel signal.

Recently, advancements in DWDM enabled combining several optical carriers to create a composite optical signal of a desired capacity. One such example of a multi-carrier optical signal is a superchannel, which is an example of high spectral efficiency (SE) that may attain transmission rates of 100 Gb/s, 400 Gb/s, 1 Tb/s, or higher. Thus, in a superchannel, subcarriers are tightly packed and consume less optical spectrum than in conventional DWDM. Another distinctive feature of superchannels is that the subcarriers in a superchannel travel from the same origin to the same destination, and are not added or removed using an OADM while in transmission. Techniques for achieving high spectral efficiency (SE) in optical networks may include the use of superchannels modulated using dual-polarization quadrature phase-shift keying (DP-QPSK) for long-haul transmission at data rates of 100 Gb/s or greater. In particular embodiments, Nyquist wavelength-division multiplexing (N-WDM) may be used in a superchannel. In N-WDM, optical pulses having a nearly rectangular spectrum are packed together in the frequency domain with a bandwidth approaching the baud rate (see also FIG. 2).

Optical transport network 101 may include one or more optical transmitters (Tx) 102 to transmit optical signals through optical transport network 101 in specific wavelengths or channels. Transmitters 102 may comprise a system, apparatus or device to convert an electrical signal into an optical signal and transmit the optical signal. For example, transmitters 102 may each comprise a laser and a modulator to receive electrical signals and modulate the information contained in the electrical signals onto a beam of light produced by the laser at a particular wavelength, and transmit the beam for carrying the signal throughout optical transport network 101. In some embodiments, optical transmitter 102 may be used to determine the baud rate for the data to be transmitted during the optical modulation. An example of transmitter 102 for applying different baud rates is an adaptive rate transponder. Additionally, a forward error correction (FEC) module may be included in optical transmitter 102, or may be used in conjunction with optical transmitter 102. The FEC module may process the electrical signal carrying the information or data to be transmitted to include error correction codes. The FEC module at transmitter 102 may also determine a baud rate for sending the data to be transmitted to optical transmitter 102 for optical modulation.

Multiplexer 104 may be coupled to transmitters 102 and may be a system, apparatus or device to combine the signals transmitted by transmitters 102, e.g., at respective individual wavelengths, into a WDM signal.

Optical amplifiers 108 may amplify the multi-channeled signals within optical transport network 101. Optical amplifiers 108 may be positioned before and after certain lengths of fiber 106, which is referred to as “in-line amplification”. Optical amplifiers 108 may comprise a system, apparatus, or device to amplify optical signals. For example, optical amplifiers 108 may comprise an optical repeater that amplifies the optical signal. This amplification may be performed with opto-electrical or electro-optical conversion. In some embodiments, optical amplifiers 108 may comprise an optical fiber doped with a rare-earth element to form a doped fiber amplification element. When a signal passes through the fiber, external energy may be applied in the form of a pump signal to excite the atoms of the doped portion of the optical fiber, which increases the intensity of the optical signal. As an example, optical amplifiers 108 may comprise an erbium-doped fiber amplifier (EDFA). However, any other suitable amplifier, such as a semiconductor optical amplifier (SOA), may be used.

OADMs 110 may be coupled to optical transport network 101 via fibers 106. OADMs 110 comprise an add/drop module, which may include a system, apparatus or device to add and drop optical signals (i.e., at individual wavelengths) from fibers 106. After passing through an OADM 110, an optical signal may travel along fibers 106 directly to a destination, or the signal may be passed through one or more additional OADMs 110 and optical amplifiers 108 before reaching a destination. In this manner, OADMs 110 may enable connection of different optical transport network topologies together, such as different rings and different linear spans.

In certain embodiments of optical transport network 101, OADM 110 may represent a reconfigurable OADM (ROADM) that is capable of adding or dropping individual or multiple wavelengths of a WDM signal. The individual or multiple wavelengths may be added or dropped in the optical domain, for example, using a wavelength selective switch (WSS) (not shown) that may be included in a ROADM.

Many existing optical networks are operated at 10 gigabit-per-second (Gbps) or 40 Gbps signal rates with 50 gigahertz (GHz) of channel spacing in accordance with International Telecommunications Union (ITU) standard wavelength grids, also known as fixed-grid spacing, which is compatible with conventional implementations of optical add-drop multiplexers (OADMs) and with conventional implementations of demultiplexers 105. However, as data rates increase to 100 Gbps and beyond, the wider spectrum requirements of such higher data rate signals often require increasing channel spacing. In traditional fixed grid networking systems supporting signals of different rates, the entire network system typically must be operated with the coarsest channel spacing (100 GHz, 200 GHz, etc.) that can accommodate the highest rate signals. This may lead to an over-provisioned channel spectrum for lower-rate signals and lower overall spectrum utilization.

Thus, in certain embodiments, optical transport network 101 may employ components compatible with flexible grid optical networking that enables specifying a particular frequency slot per channel. For example, each wavelength channel of a WDM transmission may be allocated using at least one frequency slot. Accordingly, one frequency slot may be assigned to a wavelength channel whose symbol rate is low, while a plurality of frequency slots may be assigned to a wavelength channel whose symbol rate is high. Thus, in optical transport network 101, ROADM 110 may be capable of adding or dropping individual or multiple wavelengths of a WDM, DWDM, or superchannel signal carrying data channels to be added or dropped in the optical domain. In certain embodiments, ROADM 110 may include or be coupled to a wavelength selective switch (WSS).

As shown in FIG. 1, optical transport network 101 may also include one or more demultiplexers 105 at one or more destinations of network 101. Demultiplexer 105 may comprise a system apparatus or device that acts as a demultiplexer by splitting a single composite WDM signal into individual channels at respective wavelengths. For example, optical transport network 101 may transmit and carry a forty (40) channel DWDM signal. Demultiplexer 105 may divide the single, forty channel DWDM signal into forty separate signals according to the forty different channels. It will be understood that different numbers of channels or subcarriers may be transmitted and demultiplexed in optical transport network 101, in various embodiments.

In FIG. 1, optical transport network 101 may also include receivers 112 coupled to demultiplexer 105. Each receiver 112 may receive optical signals transmitted at a particular wavelength or channel, and may process the optical signals to obtain (demodulate) the information (data) that the optical signals contain. Accordingly, network 101 may include at least one receiver 112 for every channel of the network. As shown, receivers 112 may demodulate the optical signals according to a baud rate used by transmitter 102. In some embodiments, receiver 112 may include, or may be followed by, a forward error correction (FEC) module to use the error correction codes to check the integrity of the received data. The FEC module may also correct certain errors in the data based on the error correction codes. The FEC module at receiver 112 may also demodulate the data at a specific baud rate defined for each channel at transmitter 102, as described above.

Optical networks, such as optical transport network 101 in FIG. 1, may employ modulation techniques to convey information in the optical signals over the optical fibers. Such modulation schemes may include phase-shift keying (PSK), frequency-shift keying (FSK), amplitude-shift keying (ASK), and quadrature amplitude modulation (QAM), among other examples of modulation techniques. In PSK, the information carried by the optical signal may be conveyed by modulating the phase of a reference signal, also known as a carrier wave, or simply, a carrier. The information may be conveyed by modulating the phase of the signal itself using two-level or binary phase-shift keying (BPSK), four-level or quadrature phase-shift keying (QPSK), multi-level phase-shift keying (M-PSK) and differential phase-shift keying (DPSK). In QAM, the information carried by the optical signal may be conveyed by modulating both the amplitude and phase of the carrier wave. PSK may be considered a subset of QAM, wherein the amplitude of the carrier waves is maintained as a constant.

PSK and QAM signals may be represented using a complex plane with real and imaginary axes on a constellation diagram. The points on the constellation diagram representing symbols carrying information may be positioned with uniform angular spacing around the origin of the diagram. The number of symbols to be modulated using PSK and QAM may be increased and thus increase the information that can be carried. The number of signals may be given in multiples of two. As additional symbols are added, they may be arranged in uniform fashion around the origin. PSK signals may include such an arrangement in a circle on the constellation diagram, meaning that PSK signals have constant power for all symbols. QAM signals may have the same angular arrangement as that of PSK signals, but include different amplitude arrangements. QAM signals may have their symbols arranged around multiple circles, meaning that the QAM signals include different power for different symbols. This arrangement may decrease the risk of noise as the symbols are separated by as much distance as possible. A number of symbols “m” may thus be used and denoted “m-PSK” or “m-QAM.”

Examples of PSK and QAM with a different number of symbols can include binary PSK (BPSK or 2-PSK) using two phases at 0° and 180° (or in radians, 0 and π) on the constellation diagram; or quadrature PSK (QPSK, 4-PSK, or 4-QAM) using four phases at 0°, 90°, 180°, and 270° (or in radians, 0, π/2, π, and 3π/2). Phases in such signals may be offset. Each of 2-PSK and 4-PSK signals may be arranged on the constellation diagram. Certain m-PSK signals may also be polarized using techniques such as dual-polarization QPSK (DP-QPSK), wherein separate m-PSK signals are multiplexed by orthogonally polarizing the signals. Also, m-QAM signals may be polarized using techniques such as dual-polarization 16-QAM (DP-16-QAM), wherein separate m-QAM signals are multiplexed by orthogonally polarizing the signals.

Dual polarization technology, which may also be referred to as polarization division multiplexing (PDM), enables achieving a greater bit rate for information transmission. PDM transmission comprises simultaneously modulating information onto various polarization components of an optical signal associated with a channel, thereby nominally increasing the transmission rate by a factor of the number of polarization components. The polarization of an optical signal may refer to the direction of the oscillations of the optical signal. The term “polarization” may generally refer to the path traced out by the tip of the electric field vector at a point in space, which is perpendicular to the propagation direction of the optical signal.

In certain embodiments, optical transport network 101 may transmit a superchannel, in which a plurality of subcarriers (or subchannels or channels) are densely packed in a fixed bandwidth band and may be transmitted at very high data rates, such as 400 Gb/s, 1 Tb/s, or higher. Furthermore, the superchannel may be well suited for transmission over very long distances, such as hundreds of kilometers, for example. A typical superchannel may comprise a set of subcarriers that are frequency multiplexed to form a single channel that are transmitted through optical transport network 101 as one entity. The subcarriers within the superchannel may be tightly packed to achieve high spectral efficiency.

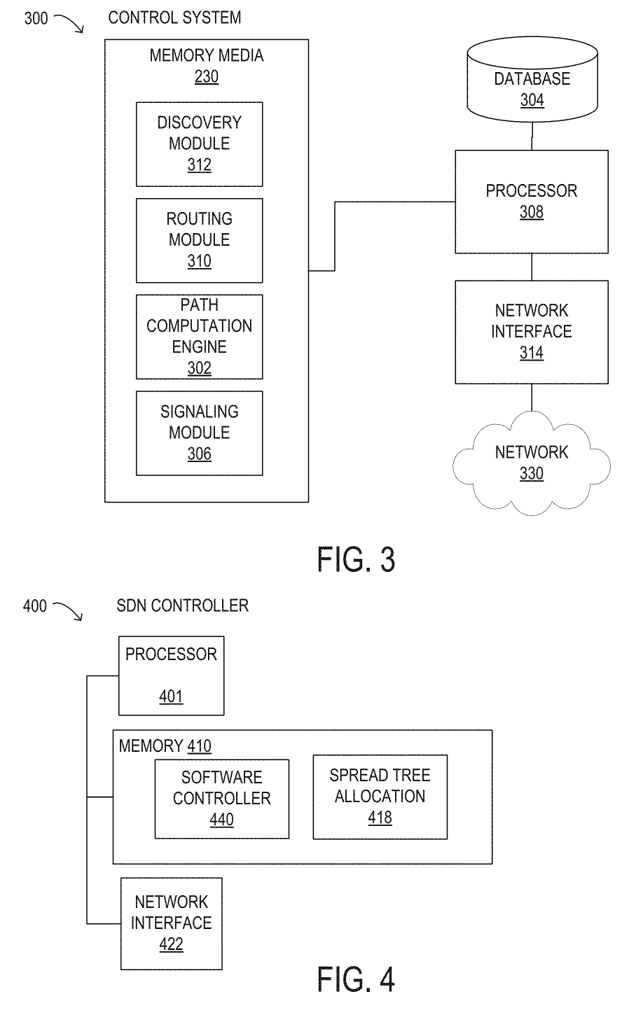

In an optical network, such as optical transport network 101 in FIG. 1, it is typical to refer to a management plane, a control plane, and a transport plane (sometimes called the physical layer). A central management host (see also FIG. 3) may reside in the management plane and may configure and supervise the components of the control plane. The management plane includes ultimate control over all transport plane and control plane entities (e.g., network elements). As an example, the management plane may consist of a central processing center (e.g., the central management host), including one or more processing resources, data storage components, etc. The management plane may be in electrical communication with the elements of the control plane and may also be in electrical communication with one or more network elements of the transport plane. The management plane may perform management functions for an overall system and provide coordination between network elements, the control plane, and the transport plane. As examples, the management plane may include an element management system (EMS) which handles one or more network elements from the perspective of the elements, a network management system (NMS) which handles many devices from the perspective of the network, or an operational support system (OSS) which handles network-wide operations.

Modifications, additions or omissions may be made to optical transport network 101 without departing from the scope of the disclosure. For example, optical transport network 101 may include more or fewer elements than those depicted in FIG. 1. Also, as mentioned above, although depicted as a point-to-point network, optical transport network 101 may comprise any suitable network topology for transmitting optical signals such as a ring, a mesh, or a hierarchical network topology.

In operation, optical transport network 101 may be used to transmit superchannels, in which a plurality of subcarrier signals are densely packed in a fixed bandwidth band and may be transmitted at very high data rates, such as 400 Gb/s, 1 Tb/s, or higher. As noted above, optical superchannels may represent a promising solution for transmission of signals at 400 Gb/s and 1 Tb/s data rate per channel. In order to minimize linear crosstalk between neighboring subcarriers in the superchannel, Nyquist filtering may be applied at the transmitter side to shape the subcarrier frequency bands (see also FIG. 2). Various transmission experiments with superchannels have revealed that each subcarrier within a superchannel may experience different amounts of linear and nonlinear interactions with neighboring subcarriers (crosstalk), resulting in different received OSNR penalties. In particular, cross-phase modulation (XPM) may limit the reach of a superchannel in optical transport network 101.

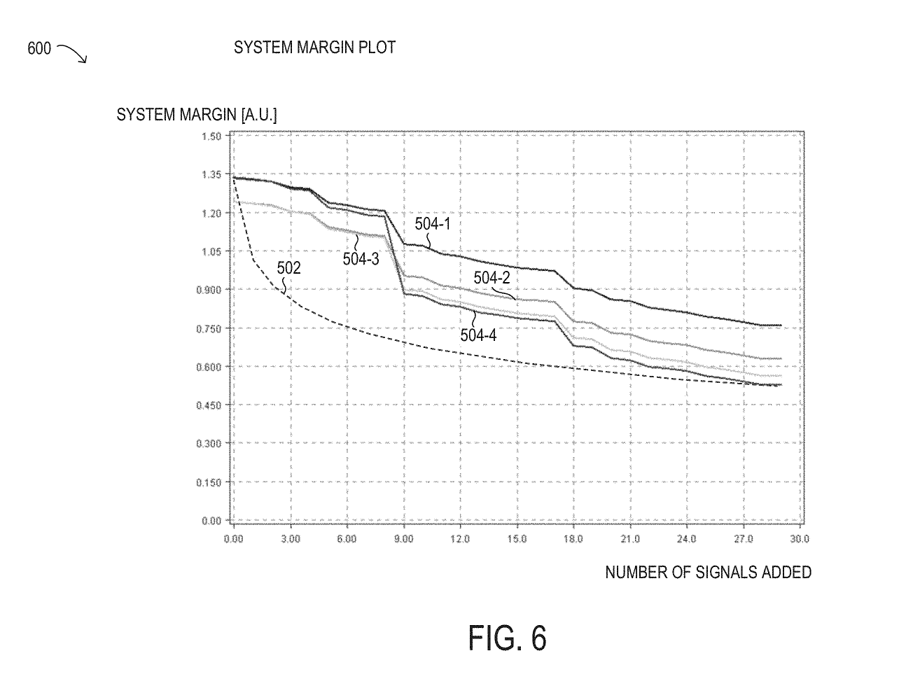

As optical signals (such as superchannels) are added to optical transport network 101, the available transmission band, the optical spectrum available for transmission of optical signals such as the C-band, is diminished. Depending on how the superchannels wavelengths are allocated in the transmission band, the effects of XPM may cause a reduction in the reach of certain optical signals, because of the decrease in OSNR as a result of XPM, which accumulates over distance along the optical fiber. As noise is added, the reach of an optical signal will decrease and the transmission of the optical signal will fail below a certain noise margin level. One way to express the capacity of optical transport network 101 is by defining a “system margin” as an available or reserve capacity of noise that can still be added (see also FIG. 6). In other words, the system margin may represent a collective noise margin for optical transport network 101. Another parameter describing optical transport network 101 is “system loading”, which defines how many other channels are being transmitted by optical transport network 101, for example, relative to an overall capacity of optical transport network 101.

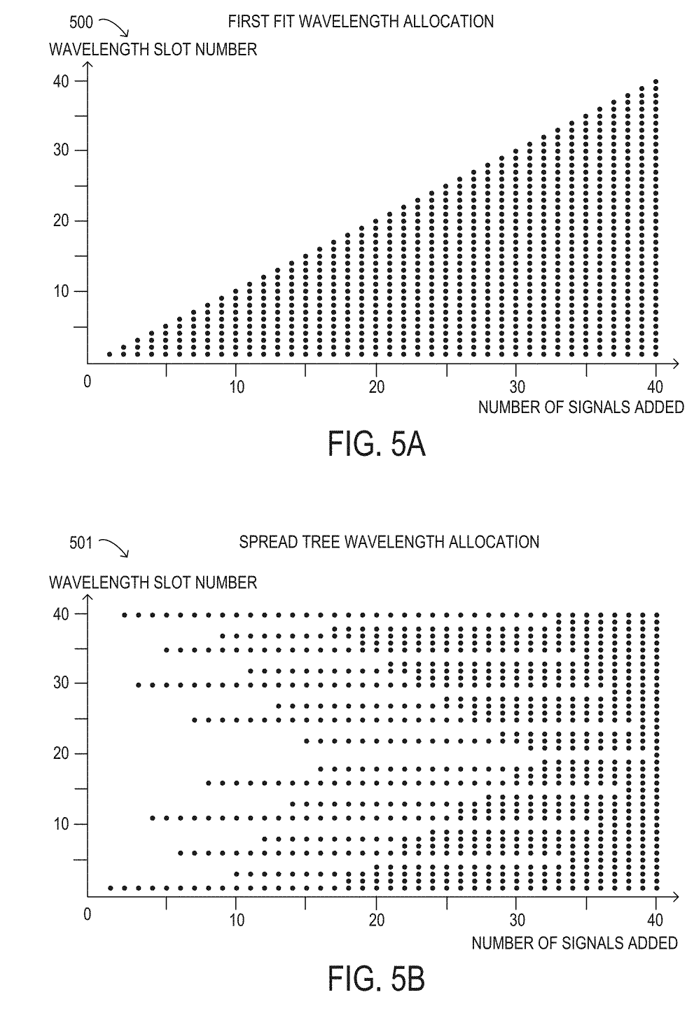

As optical transport network 101 is put to increasing use over time, additional optical paths are provisioned for optical signals and the system loading increases. However, it has been observed that the system margin is dependent on the particular procedure or algorithm used for system loading. In many typical implementations of optical transport network 101, it is assumed that eventually system loading will be 100%, which may severely limit the reach of the optical signals being transmitted by optical transport network 101, because of the increased XPM that results. For example, first fit wavelength allocation methods, such as described below with respect to FIG. 5A, may result in a rapid degradation of the system margin to a level nearly corresponding to a 100% system loading due to rapidly increasing XPM penalties, even when a full capacity of transmitted optical signals being has not been attained. Because of the rapid degradation in system margin using the first fit wavelength allocation, the assumption of operating optical transport network 101 at 100% system loading may appear justified, even when large portions of optical spectrum remain unused.

As will be described in further detail herein, methods and systems are disclosed for a spread tree wavelength allocation method in optical transport network 101 that substantially reduces the severity of signal impairing effects of system loading as optical signals are added. The spread tree wavelength allocation method disclosed herein enables greater system margins as optical signals are added to optical transport network 101. The spread tree wavelength allocation method disclosed herein may also limit or reduce fragmentation of optical transport network 101 as optical signals are added. Because of the greater system margin for a given level of system loading that the spread tree wavelength allocation method provides, the methods and systems disclosed herein for improved system loading of optical transport network 101 may provide a means to reduce operating costs of optical transport network 101 or a means to delay certain expensive capital investments in optical transport network 101 until a higher system loading occurs, which is economically desirable because of the lowered cost.

Referring to FIG. 2, selected elements of an embodiment of a superchannel is shown as superchannel power spectrum 200, which depicts five (5) subcarriers. While the data used for superchannel power spectrum 200 are not actual measured values, the illustrated power spectrum may be characteristic of an actual superchannel. In superchannel power spectrum 200, the subcarriers may each be modulated with 200 GB/s DP-16-QAM signals. Furthermore, each subcarrier band has been subject to electrical Nyquist pulse shaping in the transmitter using a root raised cosine method using a roll-off factor of 0.15. As shown in FIG. 2, B_{SC} represents the fixed superchannel transmission band, while Δf represents the subcarrier frequency spacing. In certain embodiments, the subcarrier frequency spacing Δf may be 35 GHz and may be uniform between each center frequency f₁, f₂, f₃, f₄, and f₅, respectively corresponding to the subcarriers. The subcarrier frequency spacing Δf may be selected to be wide enough to prevent any significant linear crosstalk between adjacent subcarriers. The optical signal of each subcarrier may be multiplexed using an optical coupler to form the single superchannel in the fixed transmission band B_{SC} having an aggregate data rate of 1 Tb/s, for example. It is noted that different values for the fixed superchannel transmission band, B_{SC}, the subcarrier frequency spacing Δf, and the overall aggregate data rate may result in superchannel power spectrum 200. Also shown in FIG. 2 is constant power level, P_{SC}, that is a power level for the superchannel that is substantially similar or equal for each of the 5 subcarriers, such that P_{SC}, may correspond to an average power level for each of the subcarriers.

In typical DWDM networks, it is known that system performance may depend on an allocation of each wavelength channel on the wavelength grid, such that a longer wavelength channel may suffer from smaller nonlinear impairments compared to a shorter wavelength channel. In case of superchannel-based WDM systems, in addition to the wavelength dependency of the subcarrier error rate across the transmission band, such as the C-band, a dependency of individual subcarrier error rate (or OSNR at the receiver) on spectral allocation of the subcarrier within the superchannel has been observed in the form of nonlinear impairments (such as cross-talk). Linear cross-talk may be observed between two adjacent subcarriers (inter-subcarrier) and may depend on a degree or extent of overlap in the frequency domain of the adjacent subcarriers. The use of Nyquist pulse shaping, as shown in FIG. 2, may represent an effective means for maintaining a minimum level of linear cross-talk between adjacent subcarriers, at least in part due to the nearly vertical edges of the Nyquist-shaped subcarriers (spectral pulses) that do not substantially overlap each other in the frequency domain. Non-linear cross-talk may also be observed and may arise from nonlinear interactions during fiber transmission.

The nonlinear interactions may include phenomena such as cross-phase modulation (XPM), self-phase modulation (SPM), and four-wave mixing, among others. Cross-phase modulation may occur when phase information, amplitude information, or both from one channel is modulated to an adjacent channel in the superchannel. Self-phase modulation may arise when a variation in the refractive index (or a dependency of the refractive index on intensity) results in a phase shift within each subcarrier. In four-wave mixing, three wavelengths may interact to create a fourth wavelength that may coincide with a wavelength of a subcarrier, and may lead to undesirable variations in peak power or other types of signal distortion on the affected subcarrier. Furthermore, nonlinear cross-talk may comprise inter-subcarrier components. Since nonlinear interactions occur during fiber transmission and may not depend on a degree of overlap of the subcarrier frequency bands, Nyquist pulse shaping may be ineffective in resolving certain problems with nonlinear cross-talk in a superchannel, such as XPM in particular that can limit reach of the superchannel.

Referring now to FIG. 3, a block diagram of selected elements of an embodiment of control system 300 for implementing control plane functionality in optical networks, such as, for example, in optical transport network 101 (see FIG. 1), is illustrated. A control plane may include functionality for network intelligence and control and may comprise applications that support the ability to establish network services, including applications or modules for discovery, routing, path computation, and signaling, as will be described in further detail. In particular, control system 300 may represent at least certain portions of a network management system used to implement various wavelength allocation schemes, such as the first fit wavelength allocation, and the spread tree wavelength allocation described below.

In FIG. 3, the control plane applications executed by control system 300 may work together to automatically establish services within the optical network. Discovery module 312 may discover local links connecting to neighbors. Routing module 310 may broadcast local link information to optical network nodes while populating database 304. When a request for service from the optical network is received, path computation engine 302 may be called to compute a network path using database 304. This network path may then be provided to signaling module 306 to establish the requested service.

As shown in FIG. 3, control system 300 includes processor 308 and memory media 320, which may store executable instructions (i.e., executable code) that may be executable by processor 308, which has access to memory media 320. Processor 308 may execute instructions that cause control system 300 to perform the functions and operations described herein. For the purposes of this disclosure, memory media 320 may include non-transitory computer-readable media that stores data and instructions for at least a period of time. Memory media 320 may comprise persistent and volatile media, fixed and removable media, and magnetic and semiconductor media. Memory media 320 may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, digital versatile disc (DVD), electrically erasable programmable read-only memory (EEPROM), and flash memory, non-transitory media, or various combinations of the foregoing. Memory media 320 is operable to store instructions, data, or both. Memory media 320 as shown includes sets or sequences of instructions that may represent executable computer programs, namely, path computation engine 302, signaling module 306, discovery module 312, and routing module 310.

Also shown included with control system 300 in FIG. 3 is network interface 314, which may be a suitable system, apparatus, or device operable to serve as an interface between processor 308 and network 330. Network interface 314 may enable control system 300 to communicate over network 330 using a suitable transmission protocol or standard. In some embodiments, network interface 314 may be communicatively coupled via network 330 to a network storage resource. In some embodiments, network 330 represents at least certain portions of optical transport network 101. Network 330 may also include certain portions of a network using galvanic or electronic media. In certain embodiments, network 330 may include at least certain portions of a public network, such as the Internet. Network 330 may be implemented using hardware, software, or various combinations thereof.

In certain embodiments, control system 300 may be configured to interface with a person (a user) and receive data about the optical signal transmission path. For example, control system 300 may also include or may be coupled to one or more input devices and output devices to facilitate receiving data about the optical signal transmission path from the user and to output results to the user. The one or more input or output devices (not shown) may include, but are not limited to, a keyboard, a mouse, a touchpad, a microphone, a display, a touchscreen display, an audio speaker, or the like. Alternately or additionally, control system 300 may be configured to receive data about the optical signal transmission path from a device such as another computing device or a network node, for example via network 330.

As shown in FIG. 3, in some embodiments, discovery module 312 may be configured to receive data concerning an optical signal transmission path in an optical network and may be responsible for discovery of neighbors and links between neighbors. In other words, discovery module 312 may send discovery messages according to a discovery protocol, and may receive data about the optical signal transmission path. In some embodiments, discovery module 312 may determine features, such as, but not limited to: fiber type, fiber length, number and type of components, data rate, modulation format of the data, input power of the optical signal, number of signal carrying wavelengths (i.e., channels), channel spacing, traffic demand, and network topology, among others.

As shown in FIG. 3, routing module 310 may be responsible for propagating link connectivity information to various nodes within an optical network, such as optical transport network 101. In particular embodiments, routing module 310 may populate database 304 with resource information to support traffic engineering, which may include link bandwidth availability. Accordingly, database 304 may be populated by routing module 310 with information usable to determine a network topology of an optical network.

Path computation engine 302 may be configured to use the information provided by routing module 310 to database 304 to determine transmission characteristics of the optical signal transmission path. The transmission characteristics of the optical signal transmission path may provide insight on how transmission degradation factors, such as chromatic dispersion (CD), nonlinear (NL) effects, polarization effects, such as polarization mode dispersion (PMD) and polarization dependent loss (PDL), and amplified spontaneous emission (ASE), among others, may affect optical signals within the optical signal transmission path. To determine the transmission characteristics of the optical signal transmission path, path computation engine 302 may consider the interplay between the transmission degradation factors. In various embodiments, path computation engine 302 may generate values for specific transmission degradation factors. Path computation engine 302 may further store data describing the optical signal transmission path in database 304.

In FIG. 3, signaling module 306 may provide functionality associated with setting up, modifying, and tearing down end-to-end networks services in an optical network, such as optical transport network 101. For example, when an ingress node in the optical network receives a service request, control system 300 may employ signaling module 306 to request a network path from path computation engine 302 that may be optimized according to different criteria, such as bandwidth, cost, etc. When the desired network path is identified, signaling module 306 may then communicate with respective nodes along the network path to establish the requested network services. In different embodiments, signaling module 306 may employ a signaling protocol to propagate subsequent communication to and from nodes along the network path.

In operation, the modules of control system 300 may implement a wavelength allocation scheme, as described herein. For example, as optical signals are added to optical transport network 101, control system 300 may be used to populate empty wavelengths with new optical signals. For example, control system may implement various wavelength allocation schemes, such as the first fit wavelength allocation, and the spread tree wavelength allocation described below. Furthermore, it is noted that control system 300 may function as, or may further include, a software-defined networking (SDN) controller.

Referring now to FIG. 4, a block diagram of selected elements of an embodiment of SDN controller 400 is illustrated. SDN controller 400 in FIG. 4 may be implemented to control optical network 101 (see FIG. 1) and is a schematic diagram for descriptive purposes. SDN controller 400 may represent at least certain portions of a network management system used to execute at least certain portions of the improved system loading, such as using the spread tree wavelength allocation, described herein.

In FIG. 4, SDN controller 400 is represented as a computer system including physical and logical components for controlling optical network 101, as described herein, and may accordingly include processor 401, memory 410, and network interface 422. Processor 401 may represent one or more individual processing units and may execute program instructions, interpret data, process data stored by memory 410 or SDN controller 400. It is noted that SDN controller 400 may be implemented in different embodiments. For example, in some embodiments, SDN controller 400 may be implemented using a network node. In particular embodiments, memory 410 may store executable instructions in the form of a software controller 440 executing on processor 401. As shown, memory 410 may also store spread tree allocation 418, which may represent executable code stored in memory 410 to implement the spread tree wavelength allocation described herein.

In FIG. 4, memory 410 may be communicatively coupled to processor 401 and may comprise a system, device, or apparatus suitable to retain program instructions or data for a period of time (e.g., computer-readable media). Memory 410 may include various types components and devices, such as random access memory (RAM), electrically erasable programmable read-only memory (EEPROM), a PCMCIA card, flash memory, solid state disks, hard disk drives, magnetic tape libraries, optical disk drives, magneto-optical disk drives, compact disk drives, compact disk arrays, disk array controllers, or any suitable selection or array of volatile or non-volatile memory. Non-volatile memory refers to a memory that retains data after power is turned off. It is noted that memory 410 may include different numbers of physical storage devices, in various embodiments. As shown in FIG. 4, memory 410 may include software controller 320, among other applications or programs available for execution.

Some non-limiting examples of external applications that may be used with SDN controller 300 include orchestrators (NCX, Anuta Networks, Inc., Milpitas, Calif., USA; Exanova Service Intelligence, CENX, Ottawa, Canada), workflow managers (Salesforce Service Cloud, salesforce.com, Inc., San Francisco, Calif., USA; TrackVia, TrackVia, Inc., Denver, Colo., USA; Integrify, Integrify Inc., Chicago, Ill., USA); and analytics applications (Cloud Analytics Engine, Juniper Networks, Inc., Sunnyvale, Calif., USA; Nuage Networks Virtualized Services Directory (VSD), Nokia Solutions and Networks Oy, Espoo, Finland).

Referring now to FIG. 5A, a plot 500 depicts a first fit wavelength allocation, which is a scheme by which empty wavelength slots in a transmission band of optical transport network 101 are populated. A wavelength slot may refer to one or more physical wavelength slices of the transmission band and may be fixed or variable in size, in different embodiments. In FIG. 5A, it may be assumed for interpretation of plot 500 that all wavelength slots, designated by the Y-axis (WAVELENGTH SLOT NUMBER), are equivalent and that all optical signals added, designated by the X-axis (NUMBER OF SIGNALS ADDED), are also equivalent. However, plot 500 may also be interpreted for different sizes of wavelength slots and optical signals added, in various embodiments. The Y-axis of plot 500 may depict the transmission band having 40 available wavelength slots, as a descriptive example. As shown in FIG. 5A, the first fit wavelength allocation in plot 500 begins at one end of the transmission band, with wavelength slot number 1, and incrementally adds new optical signals to successive wavelength slot numbers, as the new optical signals are added. The first fit wavelength allocation in plot 500 is often used to avoid fragmentation of the transmission band, because the remaining spectrum is maintained as a single spectral block until the entire transmission band is populated, which appears to be desirable to many network operators. However, a direct result of the first fit wavelength allocation of plot 500 is that XPM penalties are heavy beginning with the 2^{nd} optical signal added and as a result, the system margin is very quickly depleted as even a few optical signals are added (see also FIG. 6). Thus, the first fit wavelength allocation in plot 500 results in large XPM penalties that must be addressed as soon as even a few optical signals are added to optical transport network 101, which may result in expensive network equipment being added, such as optical-electrical-optical signal regenerators, in order to maintain a desired reach, even when large spectral capacity in optical transport network 101 remains available and unused.

Referring now to FIG. 5B, a plot 501 depicts a spread tree wavelength allocation, which is a scheme by which empty wavelength slots in a transmission band of optical transport network 101 are populated. In FIG. 5B, it may be assumed for interpretation of plot 501 that all wavelength slots, designated by the Y-axis (WAVELENGTH SLOT NUMBER), are equivalent and that all optical signals added, designated by the X-axis (NUMBER OF SIGNALS ADDED), are also equivalent. However, plot 501 may also be interpreted for different sizes of wavelength slots and optical signals added, in various embodiments. Although plot 501 is shown for forty (40) signals and corresponding wavelength slot numbers, it will be understood that the spread tree allocation may be implemented using any number of signals or wavelength slots. The Y-axis of plot 501 may depict the transmission band having 40 available wavelength slots, as a descriptive example. As shown in FIG. 5B, the spread wavelength allocation in plot 501 begins at one end of the transmission band, with wavelength slot number 1 being assigned to the first optical signal, and then assigns wavelength slot number 40 at the opposite end of the transmission band, to the second optical signal. Then, as shown in plot 501, successive optical signals are added in a manner such that each subsequent optical signal is added to a subsequent wavelength slot that is maximally spaced away or nearly maximally spaced away from wavelength slots previously populated with optical signals. As the subsequent optical signals are added, a symmetric or nearly symmetric population of the transmission band by the optical signals may be maintained. The spacing between subsequent wavelength slots may be determined as being maximized using different methods in various embodiments. In some embodiments, a predetermined algorithm may be employed, for example to apply a maximum spectral spacing between center wavelengths of channels or a maximum spectral spacing between spectral edges of channels. In some embodiments, a more complex algorithm may be employed to determine a maximum spectral spacing with consideration of an incremental amount and type of signal impairment of existing and new signals. For example, in the case of possible spectral hole burning by an optical amplifier, certain candidate wavelength slots may be skipped and left unpopulated with optical signals using the more complex algorithm to avoid additional signal impairments. Thus, in certain embodiments, the population of wavelength slot numbers, as shown in plot 501, may be reduced to avoid additional signal impairments, such that the total network capacity is also reduced as some wavelength slots may be left empty.

As shown above in FIGS. 5A and 5B, ultimately, as forty (40) optical signals are added, plots 500 and 501 result in the same final outcome. However, the first fit wavelength allocation in plot 500 results in substantially 100% system loading in the portions of the spectrum populated by the optical signals, while the spread tree allocation in plot 501 results in a lower system loading for any given number of signals added because the spread tree allocation effectively leaves guardbands between the populated optical channels. Thus, the spread tree allocation in plot 501 will have a higher system margin and improved reach of optical signals, particularly when the number of signals added is smaller. As a result, the spread tree allocation in plot 501 will enable lower cost operation of optical transport network 101 (until all 40 wavelength slots have been populated with optical signals), because of the reduced XPM and correspondingly increased reach of the optical signals, due to the increased system margin provided (see also FIG. 6).

In some embodiments, such as when a wavelength slot represents a fixed physical wavelength slice of the transmission band, while the spectral band occupied by any given optical signal may vary, the spread tree allocation in plot 501 may result in fragmentation of the transmission band, which is undesirable. However, the network-wide management of slots and sliced may be implemented with the spread tree allocation in plot 501 in order to minimize or eliminate undesired fragmentation. For this purpose, a so-called “unit slice” may be defined that is large enough to accommodate an optical signal having at least one channel. In one example, the transmission band may correspond to the C-band, which has 4,400 GHz of spectrum in an optical fiber. When a WDM signal that is less than or equal to 6.25 GHz is transmitted, the unit slice may correspond to a physical wavelength slice of 6.25 GHz of which 704 unit slices are available in the C-band. When superchannels are transmitted, a unit slice of 150 GHz may be used, corresponding to 24 physical wavelength slices of 6.25 GHz, and resulting in 29 unit slices in the C-band with 7 physical wavelength slices of 6.25 GHz left over. In this manner using appropriate unit slices, fragmentation in optical transport network 101 may be mitigated or substantially eliminated using the spread tree allocation in plot 501.

In some embodiments, a network-wide management of a plurality of unit slot widths may be performed, which may adjust the unit slot widths to specific spectral widths of new optical signals upon provisioning. In some embodiments, a network-wide management of unit slot center frequencies may be performed to adjust the unit slot center frequencies according to an in-service spectral translation of existing signals in the network, when also performed. For example, such an adjustment of the unit slot center frequencies may involve a re-partitioning of the C band into a new set of unit slots of various width.

FIG. 6 shows a plot 600 of system margin (in arbitrary units [A.U.]) versus number of optical signals added for optical transport network 101. Plot 600 is shown for a given distance along an optical path in an optical network with up to 29 superchannels having 4 subcarriers each and corresponding to 150 GHz, modulated using QPSK. In plot 600, plots 504 show the system margin for 4 subcarriers (504-1, 504-2, 504-3, 504-4) of the first superchannel using the spread tree allocation in plot 501, while plot 502 shows the system margin for a subcarrier of a first superchannel having the worst system margin using the first fit allocation in plot 500. As is evident from plot 600, the system margin for plots 504 is greater than plot 502, and is substantially greater up to 15 optical signals added. Thus plot 600 shows how the spread tree allocation in plot 501 can enable substantial savings for operating optical transport network 101, by enabling deferment of optical equipment, such as costly signal regeneration equipment, due to the greater available system margin, which directly translates into increased reach of optical signals. Furthermore, it may be observed that in certain mesh networks, for example where natural fragmentation occurs due to the routing of traffic in a mesh topology, system loading may be limited to about 70%. Thus, in such mesh networks, the benefits of the spread tree allocation in plot 501 may represent significant economic improvement in the operating costs of optical transport network 101.

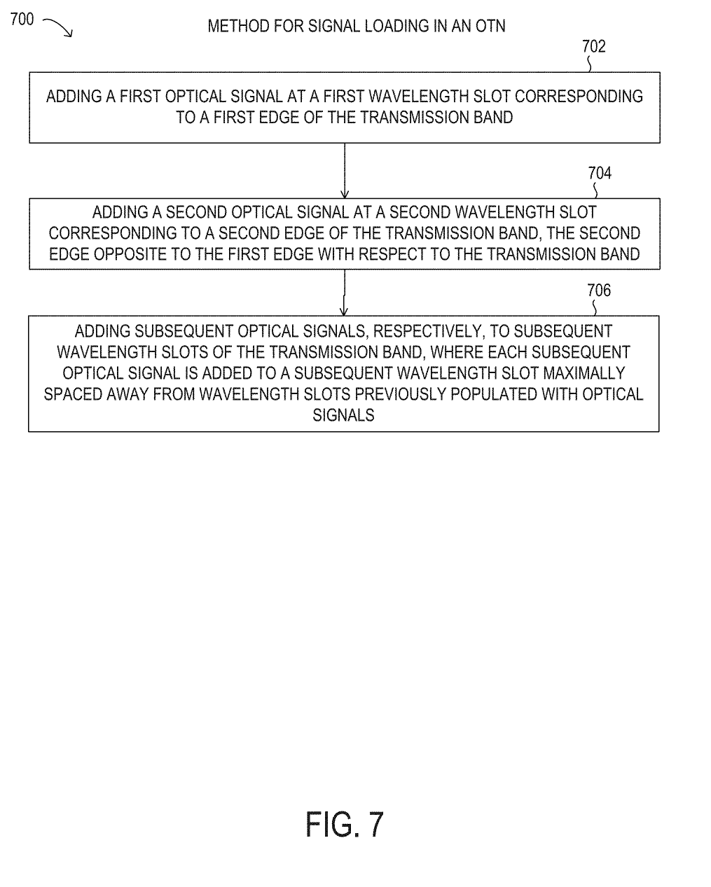

Referring now to FIG. 7, a block diagram of selected elements of an embodiment of method 700 for loading signals in an optical transport network, as described herein, is depicted in flowchart form. Method 700 may be performed using optical transport network 101. In some embodiments, method 700 may be executed by control system 300, as described above. In particular embodiments, method 700 is executed using spread tree allocation 418 (see FIG. 4). It is noted that certain operations described in method 700 may be optional or may be rearranged in different embodiments.

Method 700 may begin at step 702 by adding a first optical signal at a first wavelength slot corresponding to a first edge of the transmission band. At step 704, a second optical signal is added at a second wavelength slot corresponding to a second edge of the transmission band, the second edge opposite to the first edge with respect to the transmission band. At step 706, subsequent optical signals are added, respectively, to subsequent wavelength slots of the transmission band, where each subsequent optical signal is added to a subsequent wavelength slot maximally spaced away from wavelength slots previously populated with optical signals. As the subsequent optical signals are added, a symmetric population of the transmission band by the optical signals may be maintained (see FIG. 5B).

As disclosed herein, methods and systems for adding optical signals, such as superchannels, to an optical transport network include using a spread tree wavelength allocation in order to reduce cross-phase modulation (XPM). The spread tree wavelength allocation may result in an overall reduction in operating costs for the optical transport network as compared to a first fit wavelength allocation, for example due to reduced equipment costs for a given level of network loading.

While the subject of this specification has been described in connection with one or more exemplary embodiments, it is not intended to limit any claims to the particular forms set forth. On the contrary, any claims directed to the present disclosure are intended to cover such alternatives, modifications and equivalents as may be included within their spirit and scope.

What is claimed is:

1. A method for loading optical transport networks, the method comprising:
adding, in an optical transport network having a number of wavelength slots corresponding to a transmission band of the optical transport network, a first optical signal at a first wavelength slot corresponding to a first edge of the transmission band, wherein the transmission band is used to transmit optical signals carrying at least one channel;
adding a second optical signal at a second wavelength slot corresponding to a second edge of the transmission band, the second edge opposite to the first edge with respect to the transmission band; and
adding subsequent optical signals, respectively, to subsequent wavelength slots of the transmission band, wherein each subsequent optical signal is added to a subsequent wavelength slot maximally spaced away from wavelength slots previously populated with optical signals.

2. The method of claim 1, wherein adding the subsequent optical signals further comprises:
adding the subsequent optical signals to maintain a symmetric population of the transmission band by the optical signals.

3. The method of claim 1, wherein each of the wavelength slots represents at least one physical wavelength slice of the transmission band.

4. The method of claim 3, wherein each of the wavelength slots represents at least a number of physical wavelength slices corresponding to a channel in the optical transport network.

5. The method of claim 3, wherein each of the wavelength slots represents at least a number of physical wavelength slices corresponding to a superchannel in the optical transport network.

6. The method of claim 1, wherein adding an optical signal to the optical transport network further comprises:
provisioning an optical path for the optical signal in the optical transport network.

7. The method of claim 6, wherein provisioning the optical path further comprises:
provisioning the optical path using a software-defined networking controller.

8. The method of claim 1, wherein the transmission band is used by a plurality of optical paths transmitting the optical signals, and wherein a center wavelength and a spectral width of each of the wavelength slots, respectively, is constant among the optical paths.

9. The method of claim 1, wherein the transmission band is used by a plurality of optical paths transmitting the optical signals, and wherein a center wavelength and a spectral width of each of the wavelength slots, respectively, are varied among at least some of the optical paths.

10. An optical transport network comprising:
a number of wavelength slots corresponding to a transmission band of the optical transport network, wherein the transmission band is used to transmit optical signals carrying at least one channel;
a network management controller further comprising a processor and memory media accessible to the processor, the memory media storing instructions executable by the processor for,
adding a first optical signal at a first wavelength slot corresponding to a first edge of the transmission band;
adding a second optical signal at a second wavelength slot corresponding to a second edge of the transmission band, the second edge opposite to the first edge with respect to the transmission band; and
adding subsequent optical signals, respectively, to subsequent wavelength slots of the transmission band, wherein each subsequent optical signal is added to a subsequent wavelength slot maximally spaced away from wavelength slots previously populated with optical signals.

11. The optical transport network of claim 10, wherein the instructions for adding the subsequent optical signals further comprise instructions for:
adding the subsequent optical signals to maintain a symmetric population of the transmission band by the optical signals.

12. The optical transport network of claim 10, wherein each of the wavelength slots represents at least one physical wavelength slice of the transmission band.

13. The optical transport network of claim 12, wherein each of the wavelength slots represents at least a number of physical wavelength slices corresponding to a channel in the optical transport network.

14. The optical transport network of claim 12, wherein each of the wavelength slots represents at least a number of physical wavelength slices corresponding to a superchannel in the optical transport network.

15. The optical transport network of claim 10, wherein the instructions for adding an optical signal to the optical transport network further comprise instructions for:
provisioning an optical path for the optical signal in the optical transport network.

16. The optical transport network of claim 10, wherein the network management controller includes a software-defined networking controller.

17. A software-defined networking (SDN) controller, comprising:
a processor; and
a memory media accessible to the processor, the memory media storing instructions executable by the processor for:
adding, in an optical transport network having a number of wavelength slots corresponding to a transmission band of the optical transport network, a first optical signal at a first wavelength slot corresponding to a first edge of the transmission band, wherein the transmission band is used to transmit optical signals carrying at least one channel, and further comprising;
adding a second optical signal at a second wavelength slot corresponding to a second edge of the transmission band, the second edge opposite to the first edge with respect to the transmission band; and
adding subsequent optical signals, respectively, to subsequent wavelength slots of the transmission band, wherein each subsequent optical signal is added to a subsequent wavelength slot maximally spaced away from wavelength slots previously populated with optical signals.

18. The SDN controller of claim 17, wherein the instructions for adding the subsequent optical signals further comprise instructions for:
adding the subsequent optical signals to maintain a symmetric population of the transmission band by the optical signals.

19. The SDN controller of claim 17, wherein each of the wavelength slots represents at least one physical wavelength slice of the transmission band.

20. The SDN controller of claim 19, wherein each of the wavelength slots represents at least a number of physical wavelength slices corresponding to a channel in the optical transport network.

21. The SDN controller of claim 19, wherein each of the wavelength slots represents at least a number of physical wavelength slices corresponding to a superchannel in the optical transport network.

22. The SDN controller of claim 17, wherein the instructions for adding an optical signal to the optical transport network further comprise instructions for:
provisioning an optical path for the optical signal in the optical transport network.
